(19) United States
(12) Patent Application Publication
(10) Pub. No.: US 2006/0031498 A1
(43) Pub. Date: Feb. 9, 2006

(54) Service-process providing system and service-process providing method

(76) Inventors: Yoko Kinugawa, Yokohama (JP); Takeshi Ishizaki, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/108,709

(22) Filed: Apr. 19, 2005

(30) Foreign Application Priority Data
Apr. 20, 2004 (JP) 2004-124259

(51) Int. Cl. G06F 15/173

(52) U.S. Cl. 709/225

(57) ABSTRACT

A service provider has prepared in advance a process definition which includes only a minimum amount of service required. Then, under this condition alone, a user is requested to add a necessary service to the process definition. This permits the user to utilize a customized process. A service providing server prepares the process definition and an addable service addable thereto, thereby allowing presentation of the definition and the service to the user. In accordance with an instruction by the user, a user client makes assistances such as making a judgment on addition possibility or impossibility of the service to the process definition. The service providing server makes a judgment on execution possibility or impossibility of the service requested by the user, then dynamically adding the service to the process definition and executing the service.

### INCORPORATION BY REFERENCE

The present application claims priority from Japanese application JP-2004-124259 filed on Apr. 20, 2004, the content of which is hereby incorporated by reference into this application.

### BACKGROUND OF THE INVENTION

1. Field of the Invention

The present invention relates to a service-process providing system and method. More particularly, it relates to a service-process providing system and method for providing a process definition to the outside, and executing the process based on message reception from the outside. Here, the process definition describes execution sequence of a plurality of services.

2. Description of the Related Art

In recent years, there has been developed a Web service technology for utilizing services by using SOAP (Simple Object Access Protocol) via the Internet. Also, in recent years, development is under way concerning a process description language for describing the process in the case of continuously executing a plurality of Web services. As main specification of the process description language, there has been known a specification which is referred to as “BPEL4WS” (Business Process Execution Language for Web Services). This BPEL4WS has been proposed by Microsoft, IBM, and BEA, and is introduced in such documents as http://www-106.ibm.com/developerworks/library/ws-bpel.

As a usage of the process description language, there exists the application to a one-stop service for executing in batch a series of services whose process can be determined in advance. The configuration and mechanism of the one-stop service is as follows: Namely, a service provider generally publicizes a service process (When seen from a service user, a process including a series of services is in itself a single service. From this meaning, hereinafter, the defined process will be referred to as “service process”). Next, with reception of a message from the user as the trigger, a process control engine starts execution of the service process. The user finds it unnecessary to perform a message exchange with each service within the service process for each execution. Instead, the user has only to at first transmit in batch the information needed for the execution of the service process. This allows the user to accomplish a purpose that the user has requested with the minimum time and labor.

### SUMMARY OF THE INVENTION

The service process explained in the conventional technologies, in executing its provision and operation, results in occurrence of a problem which will be explained below.

Namely, the service process according to the conventional technologies causes the following problem to occur: Even in the case of the service process for accomplishing one and the same purpose, there exist some cases where the service process differs in details depending on the users. For example, take, as an example, a service process of a travel agency where a user A and a user B make arrangements for basically the same package tour. In this service process, a process such as sequentially reserving flight, hotel, and rental car is substantially determined on a unique basis. To the user A, however, the rental car may be unnecessary. Meanwhile, the user B may wish to apply for participation in an optional tour in addition to the flight, hotel, and rental car. As shown in this example, this service process gives rise to the case where it is difficult to deal with requests which differ depending on the users.

In the case like this, since the service process that the service user is planning to utilize includes an excessive service, it takes the service user an extra expense or time to make an arrangement therefor. Conversely, since the service process does not include a service that the service user wishes to utilize, the service user must make another arrangement therefor separately. As a result, in some cases, a dissatisfaction remains for the service, or the service users must abandon utilization of the service.

The service process according to the conventional technologies causes the above-described problem to occur. Accordingly, to the service provider, the service process becomes a problem of bringing about even a possibility of loss of the clients. As solving proposals therefor, the following ones can be considered: Namely, a proposal that the service process is defined on each user basis, and a proposal that a single service process is defined which uses a large number of conditional branches to determine selection or non-selection of an individual service in response to a user's wish. In the former solving proposal, however, it turns out that the service-process definitions exist in the number of the users. This gives rise to a problem that the existence of such large number of service-process definitions is unrealistic in the service in a travel agency which is utilized by unspecified large number of people. Simultaneously, basically the same service-process definitions exist in the large number. This gives rise to a problem that a tremendous cost becomes necessary for management of the service-process definitions and process instances. Meanwhile, in the latter solving proposal, as the number of the services increases which can be set as being selective or non-selective, the number of the conditional branches included in the single service-process definition also increases. This gives rise to a problem that the definition becomes exceedingly complicated.

It is an object of the present invention to solve the above-described problem in the service process according to the conventional technologies, and to provide a service-process providing system and method whereby, if only the service provider has prepared in advance a process definition which includes only a minimum amount of service required, the user is permitted to utilize a customized process by adding a necessary service to the process definition.

In order to solve the above-described problem, according to one feature of the present invention, there is provided a service-process providing system including a single or a plurality of service-process providing server or servers, and a service display/input device as a plurality of user clients, the server or servers and the service display/input device being connected to each other via a network, wherein the service-process providing system provides a process definition to the outside, and executes the process based on message reception from the user clients, the process definition describing execution sequence of a plurality of services, the service-process providing server including a process-definition storage device for storing a process definition which includes only a minimum amount of service required, an addable-service storage device for storing information on a service which a user can add to the process definition and can utilize, a service output unit for outputting, to the user clients, the information on the process definition and the addable service, a requested-service storage device for storing the information on the addable service on each process-instance basis, the addable service being requested by the user, and a request analysis unit for determining a service to be executed next during execution of each process instance.

The service providing server for providing the service process according to the present invention prepares the process definition and the addable service, thereby allowing presentation of the process definition and the addable service to the user. In accordance with an instruction by the user, the user client makes such assistances as making a judgment on possibility or impossibility of the addition of the addable service to the process definition. The service providing server makes a judgment on possibility or impossibility of execution of the addable service requested by the user, then dynamically adding the service to the process definition and executing the service.

According to the present invention, if only the service provider has prepared in advance a process definition which includes only a minimum amount of service required, the user is permitted to utilize a customized process by adding a necessary service to the process definition.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram for illustrating configuration of a service-process providing system according to an embodiment of the present invention;

FIG. 2 is a diagram for illustrating an example of service information stored in an addable-service storage device 102;

FIG. 3 is a diagram for illustrating an example of service information stored in an addable-service storage device 202;

FIGS. 4A to 4C are diagrams for illustrating examples of information on requested services stored in a requested-service storage device 112;

FIGS. 5A to 5B are diagrams for illustrating examples of information on requested services stored in a requested-service storage device 212;

FIG. 6 is a diagram for illustrating an example of basic process;

FIG. 7 is a diagram for illustrating an example of custom process;

FIG. 8 is a flowchart (its first one) for explaining processing steps in a service display/input device;

FIG. 9 is a flowchart (its second one) for explaining the processing steps in the service display/input device;

FIG. 10 is a flowchart (its third one) for explaining the processing steps in the service display/input device;

FIG. 11 is a flowchart for explaining processing steps in a service output unit;

FIG. 12 is a flowchart (its first one) for explaining processing steps in a request analysis unit;

FIG. 13 is a flowchart (its second one) for explaining the processing steps in the request analysis unit; and

FIG. 14 is a flowchart (its third one) for explaining the processing steps in the request analysis unit.

### DETAILED DESCRIPTION OF THE INVENTION

Hereinafter, referring to the drawings, the detailed explanation will be given below concerning embodiments of a service-process providing system according to the present invention. Incidentally, the embodiments according to the present invention which will be explained hereinafter are examples resulting from applying the present invention for services in a travel agency utilized by unspecified large number of people, such as planning and reservation of a tour schedule.

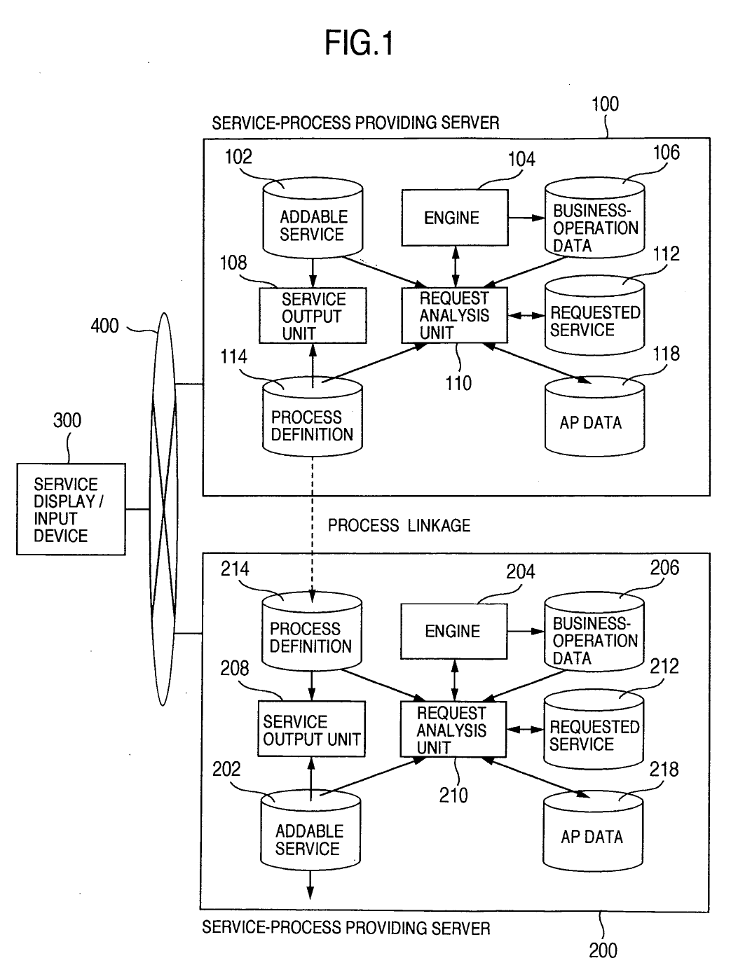

FIG. 1 is a block diagram for illustrating configuration of a service-process providing system according to an embodiment of the present invention.

The service-process providing system according to the embodiment of the present invention is configured such that a service-process providing server 100 which becomes a linkage source, a service-process providing server 200 which becomes a linkage destination, and a service display/input device 300 which allows a service user to customize a service-process definition are connected with each other via a network 400. Here, the service-process providing servers 100 and 200 provide mutually different two service processes, respectively.

The service-process providing server 100 provides a service process which is directly utilized by the user, i.e., an end user. This service process, when seen from the user, looks as if it were a single service. The service-process providing servers 100 and 200 are in a relationship of process linkage where activities in one or more service processes that the service-process providing server 100 provides executes, as a service, one or more service processes that the service-process providing server 200 provides. However, not only the user but also the service-process providing server 100 need not know details of the linkage-destination process. To the user, the service process by the service-process providing server 100 is the single service. Similarly, to the service-process providing server 100, the service process by the service-process providing server 200 is a single service as well.

Both of the service-process providing servers 100 and 200 have one and the same configuration, and are configured to include respective function components which will be explained below.

Process-definition storage devices 114 and 214 are storage devices for storing the service-process definition, and store the one or more service processes. The one or more service processes stored in the process-definition storage device 114 and the one or more service processes stored in the process-definition storage device 214, as described above, are in a relationship of the process linkage. Moreover, the process-definition storage devices 114 and 214 store the information, such as name of the service-process definition and the activities, in a manner of being made to correspond to identifiers.

Addable-service storage devices 102 and 202 are each storage devices for storing information on a service which the user can utilize by adding the service to the service-process definition. The information on the addable service has been created and publicized in advance by the service-process providing servers 100 and 200. The information on the addable service may be stored as the structured document file such as XML (extensible Markup Language), or may be stored in the table format in RDB (Relational Database).

Business-operation data storage devices 106 and 206 are each storage devices for storing states of process instances and activity instances.

Requested-service storage devices 112 and 212 are storage devices for storing the information on the addable service requested by the user on each process-instance basis. The information on the requested service is dynamically created and updated at the time of process execution by the service-process providing servers 100 and 200. The information on the requested service may be stored as the structured document file such as XML, or may be stored in the table format in RDB.

Application-data storage devices 118 and 218 are storage devices for storing application data on each process-instance basis. The application-data storage devices 118 and 218 store attribute names and values of the application data in a manner of being made to correspond to each other.

Process control engines 104 and 204 are engines for modifying state of the business-operation data.

Request analysis units 110 and 210 are units for determining a service to be executed next.

Service output units 108 and 208 are units for outputting, to the user, the process definition and the information on the addable service.

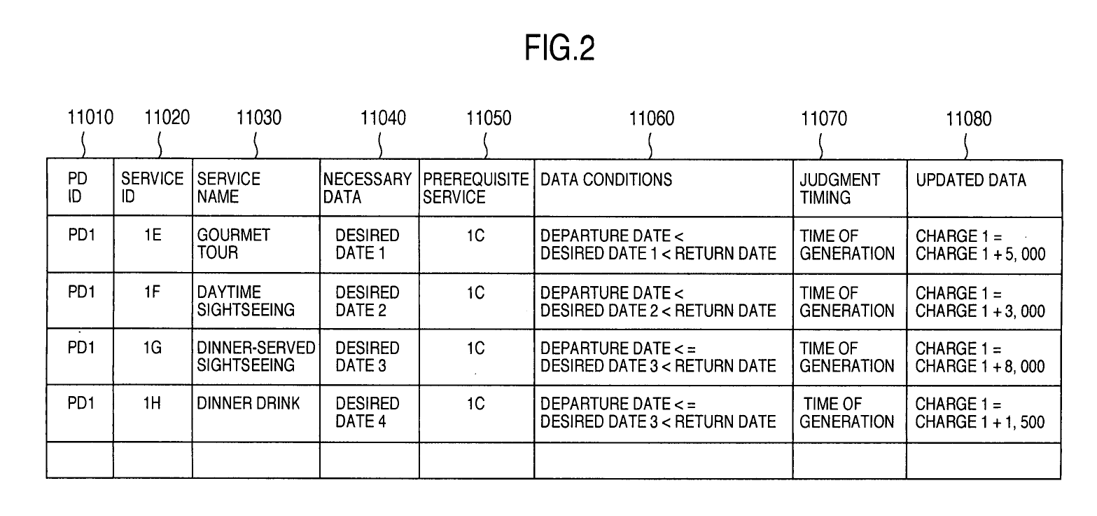

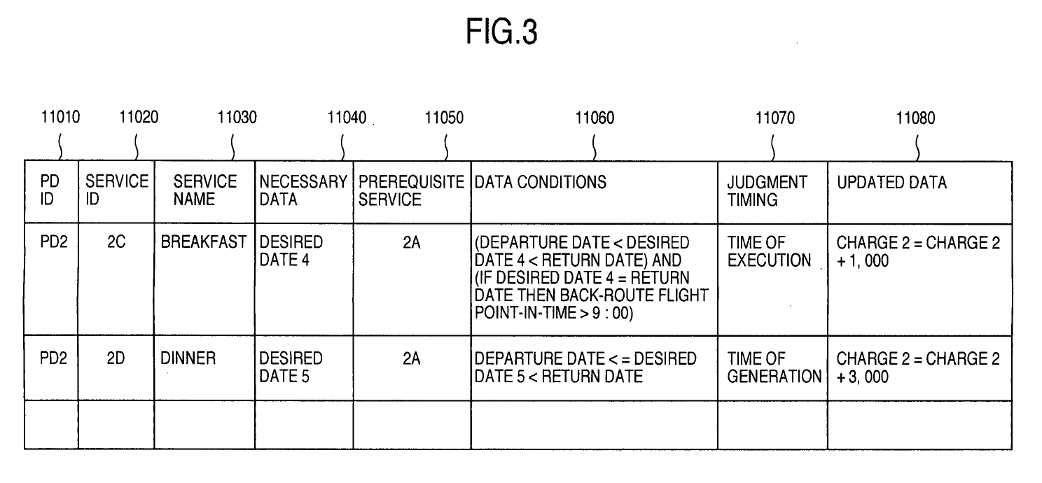

FIG. 2 is a diagram for illustrating an example of the service information stored in the addable-service storage device 102. FIG. 3 is a diagram for illustrating an example of the service information stored in the addable-service storage device 202.

As illustrated in FIG. 2 and FIG. 3, the service information stored in the addable-service storage devices 102 and 202 includes the following configuration components: Identifier (PDID) 11010 of the process definition to which the service is addable, identifier (service ID) 11020 of the service itself, name (service name) 11030 of the service, input data (necessary data) 11040 which becomes necessary as the addition when executing the service, service condition (prerequisite service) 11050 which should be completed before executing the service, data conditions (data conditions) 11060 for making a judgment on addition possibility or impossibility of the service, timing (judgment timing) 11070 for making a judgment on execution possibility or impossibility of the service, and data update method (data update) 11080 for updating data which should be updated by reflecting a result of the execution of the service.

Next, referring to the example illustrated in FIG. 3, the detailed explanation will be given below regarding the respective items. The example illustrated in FIG. 3 is an example of the travel agency which shows services addable to the service of making a hotel reservation. This example indicates that two services (service ID) 11020 “2C” and “2D” are addable to the process definition (PDID) 11010 “PD2”. The prerequisite services 11050 of these services are a service “2A” both. The necessary data 11040 of the service 11020 “2C” is “desired date 4”, which has the data conditions 11060 that includes this data. “Time of execution” set in the judgment timing 11070 indicates that it is not possible to make the judgment on addition possibility or impossibility of the service until immediately before the execution. This is because the data conditions 11060 include dynamical data whose values may be able to change during the process execution. In the case of the example of the travel agency, values of “departure date”, “return date”, and “desired date 4” do not change during the process execution. “Back-route flight point-in-time”, however, is not determined in advance, and differs depending on a result of the flight reservation during the process execution. The service 11020 “2C” includes this “back-route flight point-in-time” in the data conditions 11060, and accordingly the judgment timing 11070 is set as the “time of execution”. Meanwhile, the necessary data 11040 of the service 11020 “2D” is “desired date 5”. Although the data conditions 11060 include “departure date”, “desired date 5” and “return date”, values thereof do not change during the process execution. Consequently, its judgment timing 11070 is set as “time of generation” for indicating that it is possible to make the judgment on addition possibility or impossibility of the service 11020 at the process generation stage before the process start. Next, the updated data 11080 defines rules based on which values of the associated data are to be updated in accompaniment with the execution of the service 11020. Here, “charge 2” is data which indicates a total charge including such charges as room charge and service charge in the hotel reservation service. The updated data 11080 shows that, when the services “2C” and “2D” are added, 1,000 yen and 2,000 yen will be added to the total charge, respectively. Although, in the above-described explanation, the explanation has been given selecting FIG. 3 as the example, the explanation is also basically the same in the example of the case illustrated in FIG. 2.

The example illustrated in FIG. 2, which is the process of the entire tour arrangement, indicates that it is possible to make the judgment on addition possibility or impossibility of all the addable services 11020 at the process generation stage. “Charge 1” in the updated data 11080 is data indicating the total charge of the entire tour arrangement such as flight and hotel. Addition of a charge thereto is performed, depending on a service to be added.

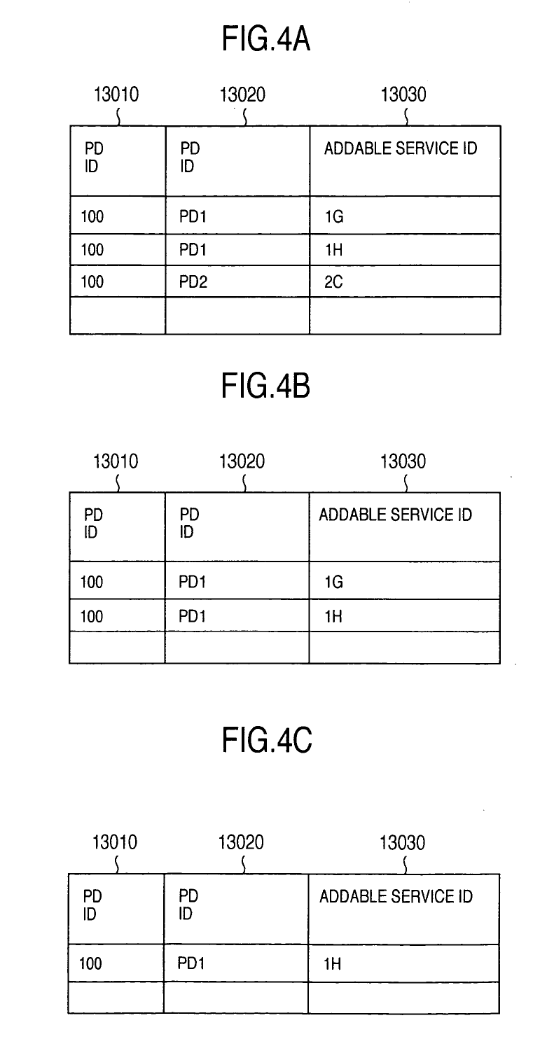

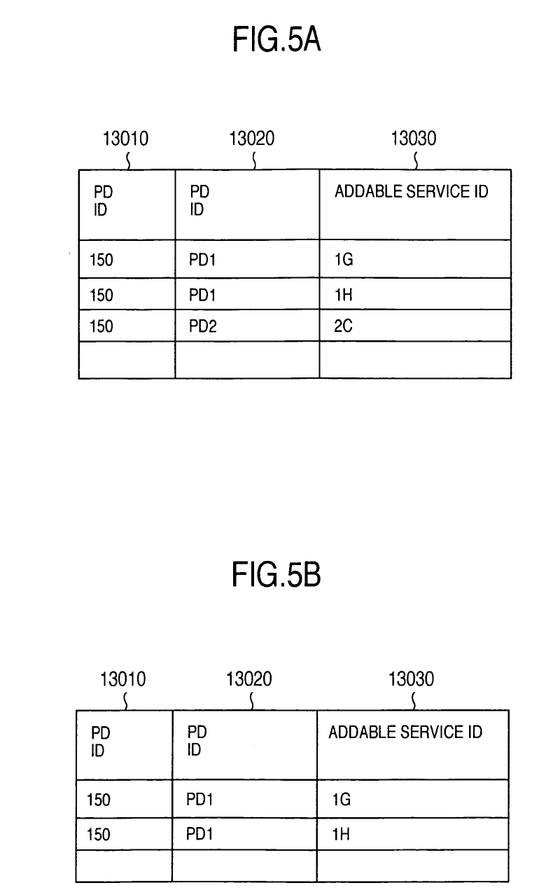

FIGS. 4A to 4C are diagrams for illustrating examples of the information on the requested services stored in the requested-service storage device 112. FIGS. 5A to 5B are diagrams for illustrating examples of the information on the requested services stored in the requested-service storage device 212. As illustrated in FIGS. 4A to 4C and FIGS. 5A to 5B, the requested-service storage devices 112 and 212 store identifier (PIID) 13010 of the process instance, the identifier (PDID) 13020 of the process definition, and the addable service (i.e., requested service) 13030 requested by the user.

Next, the explanation will be given below concerning processing steps in the embodiment of the present invention. At first, the explanation will be given regarding the process definition which becomes precondition for explaining the steps.

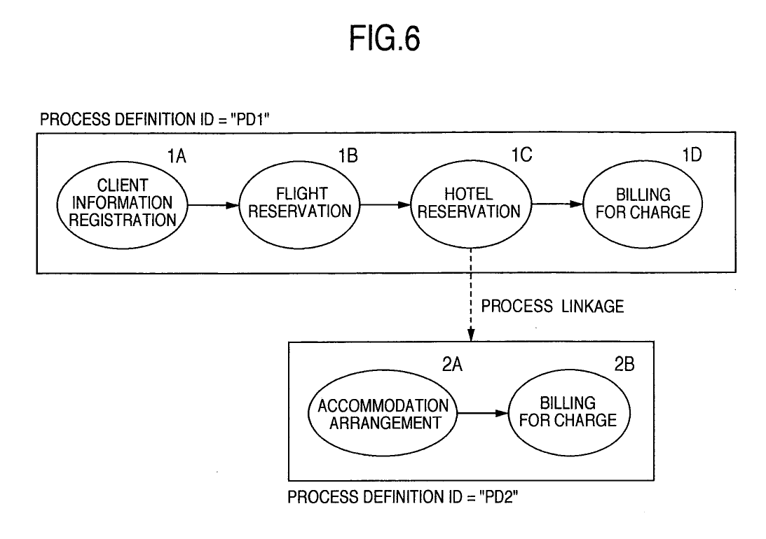

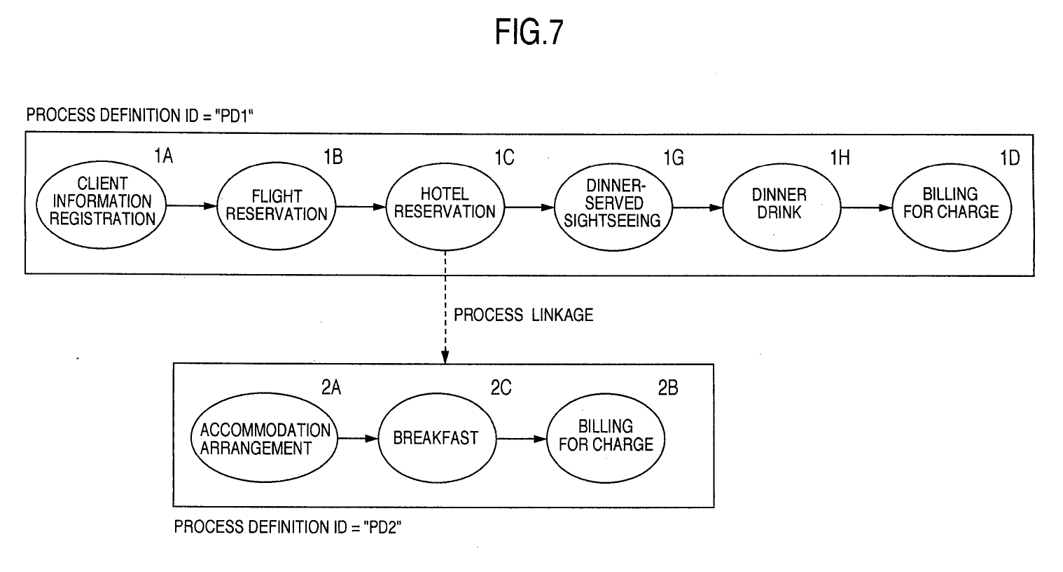

FIG. 6 is a diagram for illustrating an example of basic process. FIG. 7 is a diagram for illustrating an example of custom process.

FIG. 6 illustrates an example of service-process definition which includes only a minimum amount of service required (hereinafter, this service process will be referred to as “basic process”). Moreover, the basic process includes the process linkage. In FIG. 6, process definition ID “PD1” is a service process of making a tour reservation, and process definition ID “PD2” is a service process of making a hotel reservation. The respective service processes are executed by the service-process providing servers 100 and 200, respectively. Utilizing URI (Uniform Resource Identifiers) or the like makes it possible to uniquely identify the process definition IDs “PD1” and “PD2” on the network. Although, in the real world, a service “1B” of making a flight reservation also assumes a mode of the service process as is the case with a service “1C” of making the hotel reservation, the service will be omitted for simplicity here. Meanwhile, FIG. 7 illustrates an example of process that the user generates by adding a service to the basic process illustrated in FIG. 6 (hereinafter, this process will be referred to as “custom process”). The examples of the addable services illustrated in FIG. 2 and FIG. 3 and explained in the above-described explanation indicate the addable services addable to the process definition IDs “PD1” and “PD2”, respectively. The custom process illustrated in FIG. 7 is created by adding a “dinner-served sightseeing” service “1G” and a “dinner drink” service “1H” to the process definition ID “PD1”, and adding a “breakfast” service “2C” to the process definition ID “PD2”.

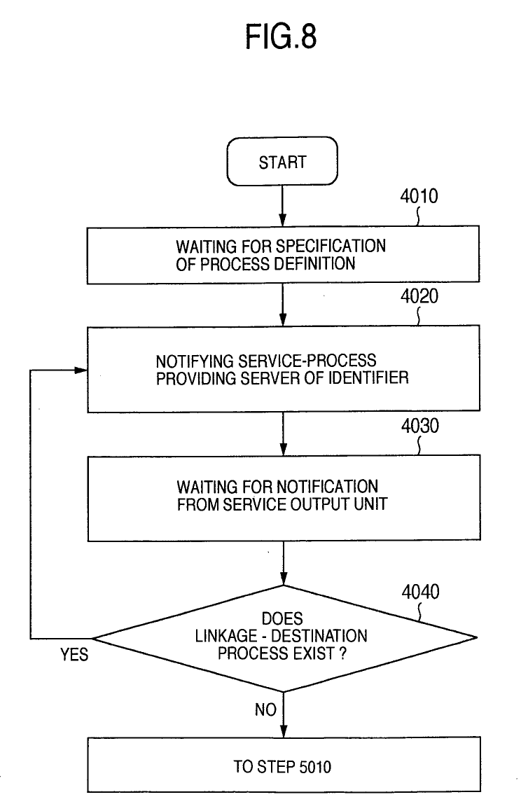

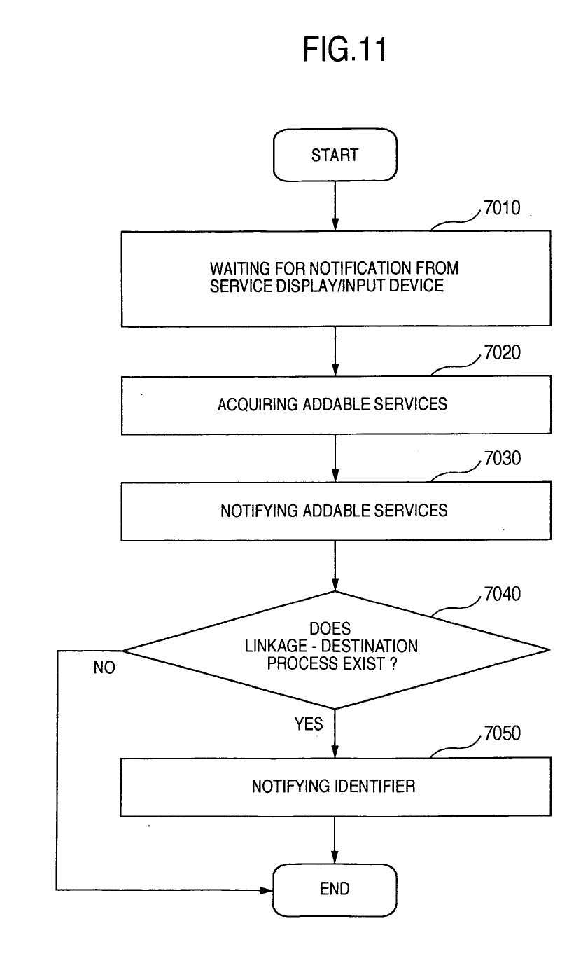

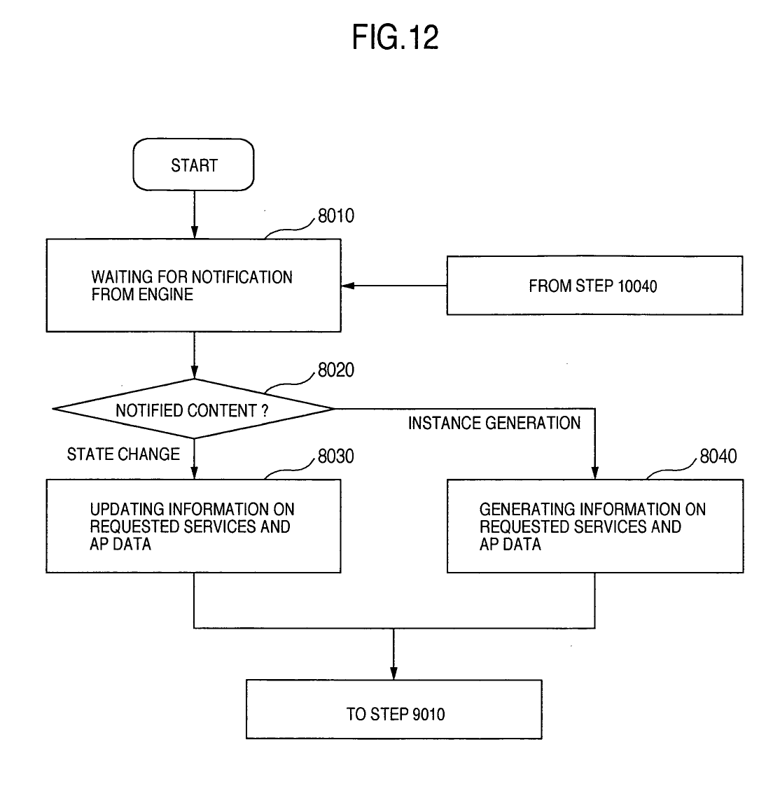

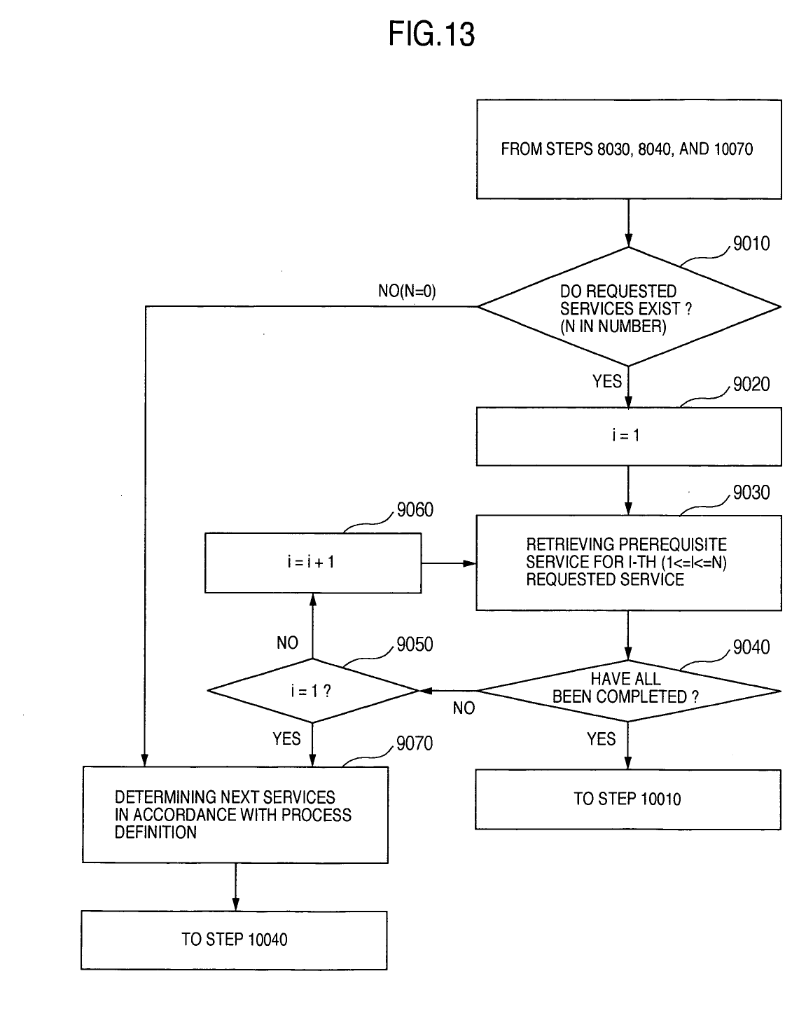

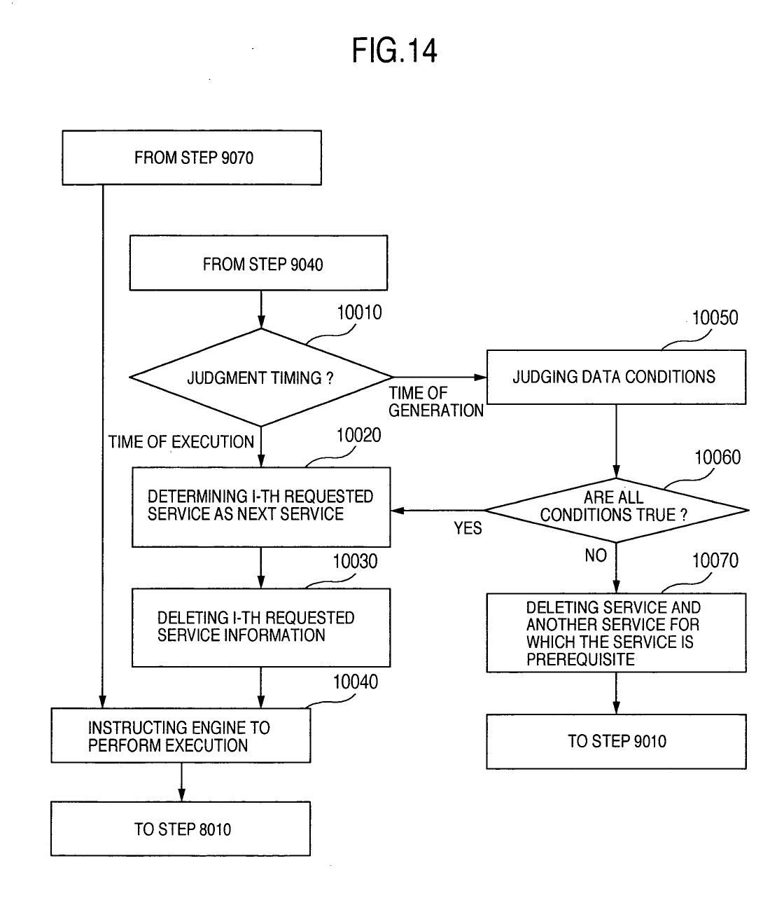

FIG. 8 to FIG. 10 are flowcharts for explaining processing steps in the service display/input device 300. FIG. 11 is a flowchart for explaining processing steps in the service output units 108 and 208. FIG. 12 to FIG. 14 are flowcharts for explaining processing steps in the request analysis units 110 and 210. Next, referring to these flowcharts, the explanation will be given below concerning the processing steps in the embodiment of the present invention. The explanation here will be given assuming that the processing in accordance with the process definitions illustrated in FIG. 6 and FIG. 7 will be executed. Also, the flowcharts illustrated in FIG. 8 and FIG. 14 operate in a manner of being collaborated with each other during the processing. Accordingly, the explanation will be given regarding these flowcharts such that these flowcharts are dealt with as a series of continuous flowcharts, and such that processing operations by the respective components illustrated in FIG. 1 in the case where the service-process user generates the custom process and processing operations by the respective components illustrated in FIG. 1 in the case where the service-process user controls execution of the custom process are divided. At first, the explanation will be given concerning the processing operations in the case where the service-process user generates the custom process.
(1) Assume that, in order for the service-process user to generate the custom process, the user specifies a process definition (which, here, is defined as the process definition “PD1”) from the service display/input device 300 (step 4010). Then, the service display/input device 300 notifies a service-process providing server (here, the service-process providing server 100) for providing the specified process definition of an identifier of the specified process definition (step 4020), then waiting for a notification from the service-process providing server 100 (step 4030).
(2) The service output unit 108 of the service-process providing server 100, which has received the notification at the step 4020, receives the notification from the service display/input device 300 (step 7010). Then, the service output unit 108 retrieves the addable-service storage device 102 with the notified identifier used as a key, thereby acquiring the addable services (here, the four services illustrated in FIG. 2) which are addable to the notified process definition (step 7020).
(3) The service output unit 108 notifies the service display/input device 300 of the addable services acquired (step 7030), and also judges whether or not a linkage-destination process exists for the process definition specified by the user in the processing at the step 4010 (step 7040). If the linkage-destination process exists, the unit 108 notifies the service display/input device 300 of an identifier (here, “PD2” since the linkage-destination process definition “PD2” exists for the process definition “PD1”) of the linkage-destination process definition (step 7050), then terminating the processing. Meanwhile if none of the linkage-destination process exists, the unit 108 terminates the processing immediately.

At this point-in-time, it turns out that the service display/input device 300 has acquired information on the addable services addable to the process definition “PD1”, and information that the linkage-destination process definition is “PD2”.
(4) The service display/input device 300, which was in the state of waiting for the notification from the service output unit 108, receives the notification from the service output unit 108 (step 4030). Then, the device 300 judges whether or not the identifier of the linkage-destination process definition has been notified (step 4040). If the identifier of the linkage-destination process definition has been notified, the device 300 replaces the identifier of the process definition specified at the step 4020 by the identifier of the linkage-destination process definition. Moreover, the device 300 repeats execution of the processing from the steps 4020 to 4040 until the linkage-destination process has been not acquired (step 4040:NO). Here, since the linkage-destination process definition “PD2” exists (step 4040:YES), the device 300 notifies the service-process providing server 200 for providing the process definition of the identifier thereof (step 4020).
(5) The service output unit 208 of the service-process providing server 200 receives the notification from the service display/input device 300 in the processing at the step 4020 (step 7010), thereby acquiring the two services illustrated in FIG. 3 (step 7020), and then notifying the service display/input device 300 of the two services acquired (step 7030). Also, the service output unit 208 judges whether or not a linkage-destination process exists for the process definition “PD2” (step 7040). In this case, since none of the linkage-destination process exists (step 7040:NO), the unit 208 terminates the processing here.

At this point-in-time, it turns out that the service display/input device 300 has acquired information that the process definition “PD1” and the process definition “PD2” are in a relationship of the process linkage, and the information on the addable services addable to each process definition.
(6) The service display/input device 300, which was in the state of waiting for the notification from the service output unit 208, receives the notification from the service output unit 208 (step 4030). Then, the device 300 judges whether or not a linkage-destination process exists (step 4040). In this case, since no further linkage-destination process exists (step 4040:NO), the device proceeds to a processing at a step 5010.

The processing explained until the above-described explanation allows the user to acquire the specified process definition including the linkage-destination process definition therefor as well, and the information on the addable services addable to each process definition.
(7) Next, the service display/input device 300 displays the process definitions and the information on the addable services acquired (step 5010). Here, the device 300 displays the process definitions illustrated in FIG. 6 (i.e., the basic process), the four services illustrated in FIG. 2 as the addable services addable to the process definition“PD1”, and the two services illustrated in FIG. 3 as the addable services addable to the process definition“PD2”.
(8) The service display/input device 300 waits for presence or absence of a specification of the addable services 11020 by the user (step 5020), then judging whether or not the specification of the addable services 11020 exists (step 5030). If the specification of the addable services 11020 exists (step 5030:YES), the device 300 makes judgments on addition possibility or impossibility of all of the addable services specified (steps 5040, 5050). The device judges this addition possibility or impossibility by judging whether or not the prerequisite services 11050 for the addable services 11020 exist in the custom process to be generated. For example, assume that the addable services 11020 “1F” and “1H” are wished to be added to the process definition “PD1”. The prerequisite service 11050 “1C” for the addable service 11020 “1F” already exists in the basic process. Accordingly, the addition of the service “1F” is judged to be possible. However, the prerequisite service 11050 “1G” for the addable service 11020 “1H” does exist in the custom process. Accordingly, the addition of the service “1H” alone is judged to be impossible. In the case like this (step 5050:NO), the service display/input device 300 prompts the user to redo the specification such that the user will abandon the addition of the service 11020 “1H” or will permit the addition of “1G” as well (step 5060).
(9) If the user specifies the addable services 11020 again (step 5020), the device 300 repeats execution of the processing from the steps 5020 to 5050 until all of the specified services 11020 become addable (step 5050:YES). Here, it is assumed that the user redoes the specification such that the services 11020 “1G” and “1H” will be added to the process definition “PD1” and such that the service 11020 “2C” will be added to the process definition “PD2”. As a result, since all of the specified services 11020 have become addable (step 5050:YES), the device 300 proceeds to a processing at a step 6010.
(10) The service display/input device 300 displays the custom process where the addable services 11020 are located such that the addable services 11020 are positioned after the prerequisite services 11050, thereby prompting the user to input application data including the necessary data 11040 for the addable services 11020 (step 6010). Here, the device 300 displays the custom process illustrated in FIG. 7, thereby prompting the user to input the data such as “departure date” and “return date” necessary for execution of the basic process, the necessary data 11040 “desired date 3” for the services 11020 “1G” and “1H”, and the necessary data 11040 “desired date 4” for “2C” (step 6010).
(11) If the user has inputted the data, the service display/input device 300 makes judgments on addition possibility or impossibility of all of the addable services 11020 specified at the step 5020. The device 300 judges this addition possibility or impossibility by evaluating true or false of the data conditions 11060 for the specified services 11020 (step 6020). However, the judgments here may be made concerning only the services 11020 for which the judgment timing 11070 is “time of generation”. With respect to the services 11020 for which the judgment timing 11070 is “time of execution”, the judgments are made immediately before the executions. Consequently, at the step 6020, the data conditions are unconditionally assumed to be “true” without making the judgments. Here, of the specified services 11020, the judgments are made regarding “1G” and “1H”. Regarding “2C”, however, the data conditions are assumed to be “true” without making the judgment.
(12) If all the results of the judged data conditions 11060 have been found to be “true” (step 6020:YES), the service display/input device 300 creates a message describing the identifiers of all of the addable services 11020 specified at the step 5020 and the data inputted at the step 6010 (step 6060), then transmitting the message to the service-process providing server for providing the service process (step 6070).
(13) Meanwhile, even if, of all the results of the judged data conditions 11060, only one of them has been found to be “false” (step 6020:NO), the device 300 prompts the user to redo the specification, then waiting for an instruction from the user. Here, redoing the specification is such that the user will re-input data which becomes a cause for “false”, or will abandon the addition of a service 11020 corresponding to the data conditions 11060 which have been found to be “false” (step 6030).
(14) The service display/input device 300 judges whether the instructed content inputted by the user is the re-input of the data or the cancellation of the service utilization (step 6040). Then, if the user cancels the addition of the service 11020 corresponding to the data conditions 11060 which have been found to be “false”, (step 6040: cancellation of service utilization), the device 300 deletes, from among the addable services 11020 specified at the step 5020, the service 11020 canceled and another addable service 11020 for which the canceled service 11020 is the prerequisite service 11050, if any (step 6050). Moreover, the service display/input device 300 creates a message describing the identifiers of the remaining addable services 11020 and the data inputted at the step 6010 (step 6060), then transmitting the message to the service-process providing server for providing the service process (step 6070).
(15) Meanwhile, if the instructed content by the user is the re-input of the data which becomes the cause for “false” (step 6040: re-input of data), the service display/input device 300 waits for the re-input of the data (step 6010), then making re-judgments on addition possibility or impossibility of the addable services 11020 (step 6020). Hereinafter, the device 300 repeats execution of the processing from the steps 6010 to 6040 until all of the data conditions 11060 have been found to be “true” (step 6020:YES), or until the user cancels the addition of the service 11020 corresponding to the data conditions 11060 which have been found to be “false”, (step 6040: cancellation of service utilization).
(16) Meanwhile, if, in the judgment at the step 5030, the specification of the addable services 11020 does not exist from the user (step 5030:NO), the custom process is the basic process itself. Accordingly, the necessary data for the addable services 11020 is unnecessary. On account of this, the service display/input device 300 prompts the user to input only the application data necessary for execution of the basic process (step 5070). Furthermore, the device 300 creates a message describing the input data (step 5080), then transmitting the message to the service-process providing server for providing the service process (step 5090).

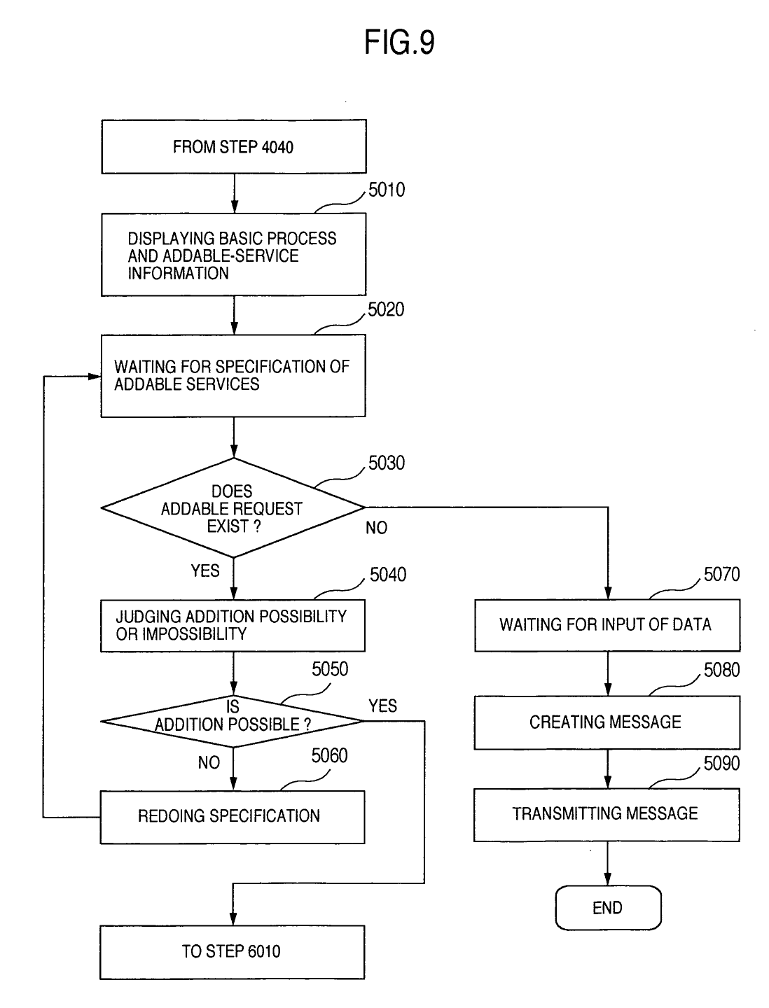

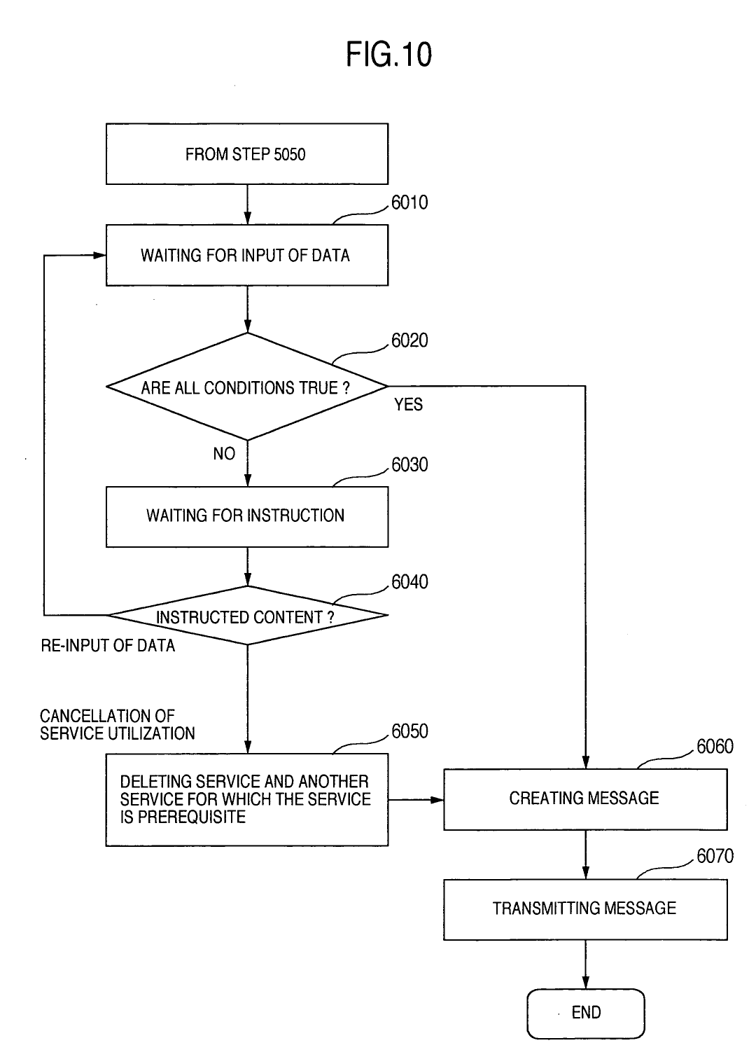

The execution of the processing illustrated in the above-described flow illustrated in FIG. 9 and FIG. 10 allows the user to create the message which, if the user wishes to add the services, describes the identifiers of the services and the application data including the data necessary for execution of the services. This makes it possible to transmit the message to the service-process providing server for providing the service process.

Here, the further explanation will be given assuming that the user has generated the custom process illustrated in FIG. 7. In order to generate this custom process, the user has added the services 11020 “1G” and “1H” to the process definition “PD1”, and the service 11020 “2C” to the process definition “PD2”. Also, the user performs the data input of the necessary data 11040 “desired date 3” and “desired date 4” necessary for execution of these services. The message describing these pieces of data and the data such as “departure date” and “return date” necessary for execution of the basic process is transmitted to the service-process providing server 100.

So far, the explanation has been given regarding the processing operations by the respective components illustrated in FIG. 1 in the case where the service-process user generates the custom process. Next, the explanation will be given below concerning the processing operations by the respective components illustrated in FIG. 1 in the case where the service-process user controls execution of the custom process.
(1) When the service-process providing server 100 has received the message from the outside, the server 100 notifies the engine 104 of the message. If none of process instances corresponding to the received message exists, a new process will be started. Accordingly, the engine 104 generates a new process instance, then storing the new process instance into the business-operation data storage device 106. If an already-existing process instance corresponding to the received message exists, the state of an under-execution activity within the process instance is changed by the message reception. Consequently, the engine 104 updates the state data stored in the business-operation data storage device 106.
(2) The request analysis unit 110 of the service-process providing server 100 waits for a notification from the engine 104, and receives the notification (step 8010). Then, the unit 110 judges whether the notified content is the new generation of the process instance or the state change of the process instance (step 8020). If the notified content is the new generation of the process instance (step 8020: instance generation), the unit 110 acquires the addable-service information from the received message, then storing the acquired addable services into the requested-service storage device 112 together with the identifier of the generated process instance (step 8040). FIG. 4A illustrates the example of the stored contents stored in the requested-service storage device 112 at this point-in-time. Also, the request analysis unit 110 acquires the application data from the received message, then storing this application data into the application-data storage device 118 (step 8040). Here, the data such as “desired date 3”, “desired date 4”, “departure date”, and “return date” will be stored. After having terminated the above-described storage processing into the requested-service storage device 112 and the application-data storage device 118, the request analysis unit 110 proceeds to a processing at a step 9010.
(3) Using, as a key, the identifier “100” of the process instance 13010 notified at the step 8010, the request analysis unit 110 retrieves the requested-service storage device 112, thereby judging whether or not there exist a request for the addable services 13030 to the process instance 13010 (step 9010).
(4) If, in the judgment at the step 9010, none of the requested addable services 13030 exists (step 9010:NO), the processing to be executed is completely the same as the execution of the basic process. Accordingly, in accordance with the process definition, the request analysis unit 110 determines services to be executed next (step 9070). Moreover, the unit 110 notifies the engine 104 of the application data stored into the application-data storage device 118, then instructing the service execution (step 10040). Consequently, the unit 110 falls into the state of waiting for the notification from the engine 104 (step 8010).
(3) Meanwhile, if, in the judgment at the step 9010, the requested addable services 13030 exist (step 9010:YES), the request analysis unit 110 retrieves the prerequisite services 11050 for the addable services 13030 from the addable-service storage device 102 (step 9020 to 9030). Furthermore, the unit 110 retrieves the states of activities for executing the prerequisite services 11050 from the business-operation data storage device 106, thereby judging whether or not all of the activities have been completed (step 9040). If all of the activities have been completed (step 9040:YES), the unit 110 provisionally determines the addable services 13030 as the services to be executed next, then proceeding to a processing at a step 10010.
(4) If, in the judgment at the step 9040, the activities for executing the prerequisite services 11050 have been not completed (step 9040:NO), the request analysis unit 110 repeats execution of the processing from the steps 9030 to 9060 until, with respect to the other addable services 13030 acquired at the step 9010, the addable services 13030 which satisfy the step 9040:YES have been acquired. Moreover, the unit 110 judges whether or not it has been successful to acquire the addable services 13030 which satisfy the step 9040:YES (step 9050). Then, if it has been found to be unsuccessful to acquire the addable services 13030 (step 9050:YES), the unit 110 determines the services to be executed next in accordance with the process definition (step 9070). This is because, at this point-in-time, any one of the addable services 13030 is not at a stage of being able to be executed. Furthermore, the unit 110 notifies the engine 104 of the application data stored into the application-data storage device 118 and the addable-service information stored into the requested-service storage device 112, then instructing the service execution (step 10040). Consequently, the unit 110 falls into the state of waiting for the notification from the engine 104 (step 8010). In the mean time, the engine 104 transmits a message describing the application data and the addable-service information notified from the request analysis unit 110, thereby executing the specified services.

The concrete explanation will be given below regarding the above-described processing. As illustrated in FIG. 4A, with respect to the process instance 13010 “100” notified at the step 8010, the two addable services 13030 “1G” and “1H” requested for the process definition 13020 “PD1” exist (step 9010:YES). The processing from the steps 9020 to 9060 is carried out regarding “1G” and “1H” until the step 9040:YES has been satisfied. At this point-in-time, however, the process instance 13010 “100” has been just generated. Accordingly, since the prerequisite services 11050 for both “1G” and “1H” have been not completed (step 9050:YES), the unit 110 determines a service “1A” as the service to be executed next in accordance with the process definition “PD1” (step 9070). Furthermore, the unit 110 notifies the engine 104 of the application data stored into the application-data storage device 118 and the addable-service information stored into the requested-service storage device 112, then instructing the service execution (step 10040). Consequently, the unit 110 falls into the state of waiting for the notification from the engine 104 (step 8010). In the mean time, the engine 104 transmits a message describing the application data and the addable-service information notified from the request analysis unit 110, thereby executing the service “1A”.
(5) When the request analysis unit 110 waits for a notification from the engine 104 and has received the notification (step 8010), the unit 110 judges the notified content (step 8020). Then, if the notification is the one of notifying that an activity for executing the service “1A” has been completed (step 8020: state change), the unit 110 acquires the addable-service information for indicating the execution result of the service “1A” from the received message, then updating the information in the requested-service storage device 112 (step 8030). However, here, no change occurs in the addable-service information, and accordingly no change occurs even if the requested-service storage device 112 has been updated. Also, the request analysis unit 110 acquires the application data from the received message, then updating the information in the application-data storage device 118 (step 8030). Although the request analysis unit 110 carries out the processing after the step 9010, since, at this point-in-time, the prerequisite services 11050 for the addable services 13030 “1G” and “1H” addable to the process definition 11010 “PD1” have also been not completed (step 9050:YES), the unit 110 determines a service “1B” as the service to be executed next in accordance with the process definition “PD1” (step 9070). Furthermore, the unit 110 carries out the step 10040 in accordance with basically the same processing step as in the case of the service “1A”. Consequently, the unit 110 falls into the state of waiting for the notification from the engine 104 (step 8010).
(6) If, in the judgment on the notified content at the step 8020, the request analysis unit 110 is notified from the engine 104 of the notification of notifying that an activity for executing the service “1B” has been completed (step 8020: state change), the unit 110 carries out the step 8030 in accordance with basically the same processing step as in the case of the service “1A”, and carries out the processing after the step 9010. At this point-in-time, however, since the prerequisite services 11050 for the addable services 13030 “1G” and “1H” addable to the process definition 11010 “PD1” have also been not completed (step 9050:YES), the unit 110 determines a service “1C” as the service to be executed next in accordance with the process definition “PD1” (step 9070). Furthermore, the unit 110 carries out the step 10040 in accordance with basically the same processing step as in the case of the services “1A” and “1B”. Consequently, the unit 110 falls into the state of waiting for the notification from the engine 104 (step 8010).

In above-described processing, the service “1C” differs from the services “1A” and “1B”, and is a service process including a plurality of services. The process definition “PD2” thereto is provided by the service-process providing server 200.

In addition, when the service-process providing server 200 has received the message from the service-process providing server 100, the server 200 notifies the engine 204 of the message. The engine 204 generates a new process instance, then storing the new process instance into the business-operation data storage device 206.
(7) When the request analysis unit 210 of the service-process providing server 200 waits for the notification from the engine 204 and has received the notification (step 8010), the unit 210 judges the notified content (step 8020). If, in this judgment, the notified content is the new generation of a process instance (step 8020: instance generation), the unit 210 acquires the addable-service information from the received message, then storing the acquired addable services into the requested-service storage device 212 together with the identifier of the generated process instance (step 8040). FIG. 5A illustrates an example of the information stored in the requested-service storage device 212 at this point-in-time. Also, the request analysis unit 210 acquires the application data from the received message, then storing this application data into the application-data storage device 218 (step 8040).
(7) After that, the request analysis unit 210 proceeds to the processing at the step 9010. Namely, using, as a key, the identifier “150” of the process instance 13010 notified at the step 8010, the unit 210 retrieves the requested-service storage device 212, thereby judging whether or not there exists a request for the addable services 13030 to the process instance 13010 (step 9010). With respect to the process instance 13010 “150”, the one addable service 13030 “2C” requested for the process definition 13020 “PD2” exist (step 9010:YES). At this point-in-time, however, the process instance 13010 “150” has been just generated. Accordingly, since the prerequisite service 11050 for “2C” has been not completed (step 9050:YES), the unit 210 determines the service “2A” as the service to be executed next in accordance with the process definition “PD2” (step 9070). Furthermore, the unit 210 notifies the engine 204 of the application data stored into the application-data storage device 218 and the addable-service information stored into the requested-service storage device 212, then instructing the service execution (step 10040). Consequently, the unit 210 falls into the state of waiting for the notification from the engine 204 (step 8010). In the mean time, the engine 204 transmits a message describing the application data and the addable-service information notified from the request analysis unit 210, thereby executing the service “2A”.
(8) If, in the judgment at the step 8020, the notified content is the one of notifying from the engine 204 that an activity for executing the service “2A” has been completed (step 8020: state change), the unit 210 acquires the addable-service information for indicating the execution result of the service “2A” from the received message, then updating the information in the requested-service storage device 212 (step 8030). However, here, no change occurs in the addable-service information, and accordingly no change occurs even if the requested-service storage device 112 has been updated. Also, the request analysis unit 210 acquires the application data from the received message, then updating the information in the application-data storage device 218 (step 8030).
(9) After that, the request analysis unit 210 proceeds to the processing at the step 9010. Namely, using, as the key, the identifier “150” of the process instance 13010 acquired at the step 8010, the unit 210 retrieves the requested-service storage device 212, thereby judging whether or not there exist the request for the addable services 13030 to the process instance 13010 (step 9010). With respect to the process instance 13010 “150”, the one addable service 13030 “2C” requested for the process definition 13020 “PD2” exist (step 9010:YES). Accordingly, the request analysis unit 210 retrieves the prerequisite service 11050 for the addable service. 13030 “2C” from the addable-service storage device 202 (step 9020 to 9030), thereby acquiring the prerequisite service 11050 “2A”. Furthermore, since the prerequisite service 11050 “2A” has been already completed at this point-in-time (step 9040:YES), the unit 110 provisionally determines the addable service 13030 “2C” as the service to be executed next, then proceeding to the processing at the step 10010.
(10) The request analysis unit 210 judges the judgment timing 11070 for the provisionally-determined addable service 13030 (step 10010). If the judgment timing 11070 is “time of generation” (step 10010: time of generation), since it has been already determined at the time of the custom-process generation that the service 13030 is executable, the unit 210 formally or officially determines this service 13030 as the service to be executed next (step 10020). Moreover, the unit 210 deletes the service 13030 from the requested-service storage device 212 (step 10030). Furthermore, the unit 210 notifies the engine 204 of the application data stored into the application-data storage device 218 and the addable-service information stored into the requested-service storage device 212, then instructing the service execution (step 10040). Consequently, the unit 210 falls into the state of waiting for the notification from the engine 204 (step 8010).
(11) Meanwhile, if, in the judgment at the step 10010, the judgment timing 11070 for the provisionally-determined addable service 13030 is “time of execution” (step 10010: time of execution), the request analysis unit 210 evaluates all of the data conditions 11060 that the service 13030 has (step 10050), thereby judging whether or not all of the data conditions 11060 are “true”. If, in this judgment, all of the data conditions have been found to be “true” (step 10060:YES), since the service 13030 is executable, the unit 210 carries out the processing at the steps 10020 to 10040 and 8010. Even if only one of the data conditions has been found to be “false” (step 10060:NO), since the service 13030 is not executable, the unit 210 deletes, from the requested-service storage device 212, the service 13030 and another addable service 13030 for which the service 13030 is the prerequisite service 11050, if any (step 10070). In addition, the unit 210 retrieves the requested-service storage device 212, thereby judging whether or not there exists another request for the addable services 13030 (step 9010).

The concrete explanation will be given below regarding the above-described processing. Up to the step 10010, the judgment timing 11070 for the provisionally-determined addable service 13030 “2C” is “time of execution” (step 10010: time of execution). Accordingly, the unit 210 evaluates all of the data conditions 11060 for the service 13030 “2C” (step 10050). The data conditions 11060 for the service 13030 “2C” are as follows: (departure date<desired date 4<return date) AND (IF desired date 4=return date THEN back-route flight point-in-time>9:00), which include the value of “back-route flight point-in-time”, i.e., the execution result of the service “1B”. From the data conditions 11060, if the back-route flight point-in-time is 9:00 or thereinafter, the service 13030 “2C” can be utilized even at the return date. If, however, the back-route flight point-in-time is 9:00 or thereinbefore, the service 13030 “2C” cannot be utilized. Here, the explanation will be given assuming that the back-route flight point-in-time is 9:00 or thereinafter.
(12) The evaluation result of the data conditions 11060 for the service 13030 “2C” is “true” (step 10060:YES). Accordingly, the request analysis unit 210 determines “2C” as the service to be executed next (step 10020). Moreover, the unit 210 deletes the service 13030 “2C” from the requested-service storage device 212 (step 10030). FIG. 5B illustrates an example of the information stored in the requested-service storage device 212 at this point-in-time. Furthermore, the unit 210 notifies the engine 204 of the application data stored into the application-data storage device 218 and the addable-service information stored into the requested-service storage device 212, then instructing the service execution (step 10040). Consequently, the unit 210 falls into the state of waiting for the notification from the engine 204 (step 8010).
(13) When the request analysis unit 210 waits for the notification from the engine 204 and has received the notification (step 8010), the unit 210 judges the notified content (step 8020). If the notified content of the received notification is the one of notifying that an activity for executing the service “2C” has been completed (step 8020: state change), the unit 210 acquires the addable-service information for indicating the execution result of the service “2C” from the received message, then updating the information in the requested-service storage device 212 (step 8030). However, here, no change occurs in the addable-service information, and accordingly no change occurs even if the requested-service storage device 212 has been updated. Also, the request analysis unit 210 acquires the application data from the received message, then updating the information in the application-data storage device 218 (step 8030). Moreover, the addable service “2C” which does not exist in the basic process has been executed. Consequently, in some cases, there exists application data whose value must be updated in accompaniment with the execution of “2C”. In view of this situation, the unit 210 acquires, from the addable-service storage device 202, the updated data 11080 “charge 2=charge 2+1,000” for the service 11020 “2C”. Here, the unit 210 updates the application data at the step 8030, and simultaneously updates the data “charge 2” in accordance with the rules (such as the formulas shown in “updated data” column in FIG. 3).
(14) Next, the request analysis unit 210 proceeds to the processing at the step 9010, thereby judging whether or not there exists a requested service (step 9010). However, there exists no more addable service 13030 which is requested for the process definition “PD2” (step 9010:NO). Accordingly, the unit 210 determines the service “2B” as the service to be executed next in accordance with the process definition “PD2” (step 9070). Furthermore, the unit 210 notifies the engine 204 of the application data stored into the application-data storage device 218 and the addable-service information stored into the requested-service storage device 212, then instructing the service execution (step 10040). Consequently, the unit 210 falls into the state of waiting for the notification from the engine 204 (step 8010). In the mean time, the engine 204 transmits the message describing the application data and the addable-service information notified from the request analysis unit 210, thereby executing the service “2B”.
(15) The request analysis unit 210 judges the content of the notification from the engine 204 (step 8020). If the notification is the one of notifying that an activity for executing the service “2B” has been completed (step 8020: state change), the unit 210 acquires the addable-service information for indicating the execution result of the service “2B” from the received message, then updating the information in the requested-service storage device 212 (step 8030). However, here, no change occurs in the addable-service information, and accordingly no change occurs even if the requested-service storage device 212 has been updated. Also, the request analysis unit 210 acquires the application data from the received message, then updating the information in the application-data storage device 218 (step 8030).
(16) The request analysis unit 210 proceeds to the processing at the step 9010, thereby judging whether or not there exists a requested service (step 9010). Here, since there exists no more addable service 13030 which is requested for the process definition “PD2” (step 9010:NO), the unit 210 determines the service to be executed next in accordance with the process definition “PD2”. However, since all of the services in the basic process have been completed, the unit 210 determines completion of the process instance (step 9070). Furthermore, the unit 210 notifies the engine 204 of the application data stored into the application-data storage device 218 and the addable-service information stored into the requested-service storage device 212, then instructing the instance completion (step 10040). Consequently, the unit 210 falls into the state of waiting for the notification from the engine 204 (step 8010).
(17) The engine 204 completes the process instance “150” for the process definition “PD2”, then transmitting, to the service-process providing server 100, a message describing the application data and the addable-service information notified from the request analysis unit 210. Moreover, if the service-process providing server 100 has received the message from the service-process providing server 200, the server 100 notifies the engine 104 of a notice to the effect. Since the already-existing instance “100” corresponding to the received message exists, the engine 104 completes the under-execution activity “1C” within the process instance.
(18) The request analysis unit 110, which has fallen into the state of waiting for the notification from the engine 104 (step 8010), judges the content of the notification from the engine 104 (step 8020) If the notification is the one of notifying from the engine 104 that the service “1C” has been completed (step 8020: state change), the unit 110 acquires the addable-service information for indicating the execution result of the service “1C” from the received message, then updating the information in the requested-service storage device 112 (step 8030). FIG. 4B illustrates an example of the information stored in the requested-service storage device 112 at this point-in-time. Also, the request analysis unit 110 acquires the application data from the received message, then updating the information in the application-data storage device 118 (step 8030).
(19) The request analysis unit 110 proceeds to the processing at the step 9010. Namely, using, as the key, the identifier “100” of the process instance 13010 notified at the step 8010, the unit 110 retrieves the requested-service storage device 112, thereby judging whether or not there exists the request for the addable services 13030 to the process instance 13010 (step 9010). In this case, with respect to the process instance 13010 “100”, the two addable services 13030 “1G” and “1H” requested for the process definition 13020 “PD1” exist (step 9010:YES). On account of this, with respect to the 1st “1G” (step 9020), the request analysis unit 110 retrieves the prerequisite service 11050 for “1G” from the addable-service storage device 102, thereby acquiring the prerequisite service 11050 “1C” (step 9030). Furthermore, the unit 110 judges whether or not the processing of this prerequisite service “1C” has been completed (step 9040). Since “1C” has been already completed at this point-in-time (step 9040:YES), the unit 110 provisionally determines “1G” as the service to be executed next, then proceeding to the processing at the step 10010.
(20) The request analysis unit 110 judges the judgment timing (step 10010). Then, since the judgment timing 11070 for the provisionally-determined service 13030 “1G” is “time of generation” (step 10010: time of generation), the unit 110 determines this service 13030 “1G” as the service to be executed next (step 10020). Moreover, the unit 110 deletes the service 13030 from the requested-service storage device 112 (step 10030). FIG. 4C illustrates an example of the information stored in the requested-service storage device 112 at this point-in-time. Furthermore, the request analysis unit 110 notifies the engine 204 of the application data stored into the application-data storage device 118 and the addable-service information stored into the requested-service storage device 112, then instructing the service execution (step 10040). Consequently, the unit 110 falls into the state of waiting for the notification from the engine 104 (step 8010).
(21) When the-request analysis unit 110 waits for the notification from the engine 104 and has received the notification (step 8010), the unit 110 judges the notified content from the engine 104 (step 8020). If the notification is the one of notifying that an activity for executing the service “1G” has been completed (step 8020: state change), the unit 110 acquires the addable-service information for indicating the execution result of the service “1G” from the received message, then updating the information in the requested-service storage device 112 (step 8030). However, here, no change occurs in the addable-service information, and accordingly no change occurs even if the requested-service storage device 112 has been updated. Also, the request analysis unit 110 acquires the application data from the received message, then updating the information in the application-data storage device 118 (step 8030). Moreover, the addable service “1G” which does not exist in the basic process has been executed. Consequently, in some cases, there exists application data whose value must be updated in accompaniment with the execution of “1G”. In view of this situation, the request analysis unit 110 acquires, from the addable-service storage device 102, the updated data 11080 “charge 1=charge 1+8,000” for the service 11020 “1G”. Here, the unit 110 updates the application data at the step 8030, and simultaneously updates the data “charge 1” in accordance with the rules.
(22) After that, the request analysis unit 110 proceeds to the processing at the step 9010. Namely, using, as the key, the identifier “100” of the process instance 13010 notified at the step 8010, the unit 110 retrieves the requested-service storage device 112, thereby judging whether or not there exists the request for the addable services 13030 to the process instance 13010 (step 9010). With respect to the process instance 13010 “100”, the one addable service 13030 “1H” requested for the process definition 13020 “PD1” exists (step 9010:YES). Accordingly, the unit 110 retrieves the prerequisite service 11050 for “1H” from the addable-service storage device 102 (steps 9020 to 9030), thereby acquiring the prerequisite service 11050 “1G”. Here, since “1G” has been already completed at this point-in-time (step 9040:YES), the unit 110 provisionally determines “1H” as the service to be executed next, then proceeding to the processing at the step 10010.
(23) The request analysis unit 110 judges the judgment timing for the provisionally-determined service 13030 “1H”. Then, since the judgment timing is “time of generation” (step 10010: time of generation), the unit 110 determines this service 13030 “1H” as the service to be executed next (step 10020). Moreover, the unit 110 deletes the service 13030 from the requested-service storage device 112 (step 10030). At this point-in-time, no more addable-service information to the instance 13010 “100” exists in the requested-service storage device 112. Furthermore, the request analysis unit 110 notifies the engine 104 of the application data stored into the application-data storage device 118, then instructing the service execution (step 10040). Consequently, the unit 110 falls into the state of waiting for the notification from the engine 104 (step 8010).
(24) The request analysis unit 110 judges the content of the notification that the unit 110 has received from the engine 104 in the state of waiting therefor (step 8020). If the received notification is the one of notifying that an activity for executing the service “1H” has been completed (step 8020: state change), the unit 110 acquires the application data for indicating the execution result of the service “1H” from the received message, then updating the application-data storage device 118 (step 8030). Moreover, the addable service “1H” which does not exist in the basic process has been executed. Consequently, in some cases, there exists application data whose value must be updated in accompaniment with the execution of “1H”. On account of this, the request analysis unit 110 acquires, from the addable-service storage device 102, the updated data 11080 “charge 1=charge 1+1,500” for the service 11020 “1H”. Here, the unit 110 updates the application data at the step 8030, and simultaneously updates the data “charge 1” in accordance with the rules. Meanwhile, no addable-service information exists in the received message, and no addable-service information to the instance “100” exists in the requested-service storage device 112. As a result, no change occurs in the requested-service storage device 112.
(25) Next, the request analysis unit 110 proceeds to the processing at the step 9010, thereby judging whether or not there exists a requested service. Here, since there exists no more addable service 13030 which is requested for the process definition “PD1” (step 9010:NO), the unit 110 determines the service to be executed next in accordance with the process definition “PD1”. However, since all of the services in the basic process have been completed, the request analysis unit 110 determines completion of the process instance (step 9070). Furthermore, the unit 110 notifies the engine 104 of the application data stored into the application-data storage device 118 and the addable-service information stored into the requested-service storage device 112, then instructing the instance completion (step 10040). Consequently, the unit 110 falls into the state of waiting for the notification from the engine 104 (step 8010).
(26) The engine 104 completes the process instance “100” for the process definition “PD1”, then transmitting, to the service display/input device 300 of the user, a message describing the application data notified from the request analysis unit 110.

Each processing in the above-described embodiments of the present invention can be configured as a processing program. This processing program can be provided in a manner of being stored into a recording medium such as HD, DAT, FD, MO, DVD-ROM, or CD-ROM.

So far, the explanation has been given concerning the processing operations by the respective components illustrated in FIG. 1 in the case where the service-process user generates the custom process. In the embodiments of the present invention, the execution of the above-described processings allows the custom process to be executed even in the case where a plurality of service-process providing devices are in a relationship of the process linkage. Here, the custom process is a process generated by adding a service that the user requests to the basic process.

According to the above-described embodiments of the present invention, if there exists a service that a user wishes to add, the user can create a message which describes the identifier thereof and application data including data necessary for the execution thereof, and can transmit the message to a service-process providing server. Moreover, the user generates a custom process, i.e., a process generated by adding the service to a basic process. Here, instead of transmitting information on the entire custom process, the user has only to transmit only information on the addable service. This makes a small transmission data amount satisfying enough. Also, instead of managing the information on the entire custom process, the service-process providing server has only to manage only the information on the addable portion.

Also, according to the above-described embodiments of the present invention, the user can generate and execute the custom process even in the case where a plurality of service-process providing servers are in a relationship of the process linkage. The user need not know details of the linkage-destination process definition, but has only to know only the identifier thereof.

In the above-described embodiments of the present invention, the explanation has been given assuming that the two service-process providing servers are in a relationship of the process linkage. The present invention, however, can be configured such that larger number of service-process providing servers are set to be collaborated, or such that there is provided only one service-process providing server.

It should be further understood by those skilled in the art that although the foregoing description has been made on embodiments of the invention, the invention is not limited thereto and various changes and modifications may be made without departing from the spirit of the invention and the scope of the appended claims.

1. A service-process providing system, comprising:
a single or a plurality of service-process providing server, and
a service display/input device as a plurality of user clients, said servers and said service display/input device being connected to each other via a network,
wherein said service-process providing system provides a process definition to the outside, and executes said process based on message reception from said user clients, said process definition describing execution sequence of a plurality of services, said service-process providing server comprising:
a process-definition storage device for storing a process definition which includes a minimum amount of service required,
an addable-service storage device for storing information on a service which a user can add to said process definition and can utilize,
a service output unit for outputting, to said user clients, said information on said process definition and said addable service,
a requested-service storage device for storing said information on said addable service on each process-instance basis, said addable service being requested by said user, and
a request analysis unit for determining a service to be executed next during execution of each process instance.

2. The service-process providing system according to claim 1, wherein said addable-service storage device stores an identifier of said process definition to which said service is addable, identifier and name of said service itself, input data which becomes necessary as addition when executing said service, a prerequisite-service condition which should be completed before executing said service, data conditions for making a judgment on addition possibility or impossibility of said service, timing information for making a judgment on execution possibility or impossibility of said service, and a data update method for updating data which should be updated by reflecting a result of said execution of said service.

3. The service-process providing system according to claim 1, wherein said addable-service storage device stores an identifier of said process instance, an identifier of said process definition, and said addable service requested by said user.

4. The service-process providing system according to claim 1, wherein said service output unit notifies said user client of said information on said process definition an and said addable service addable to said process definition, and an identifier of a possible linkage-destination process definition.

5. The service-process providing system according to claim 1, wherein said user client
acquires said information on said process definition and said addable service addable to said process definition, including said information on a possible linkage-destination process definition, and
displays said acquired information to said user, and waits for an instruction therefrom, and,
if any instruction of addition of said service exists, judges addition possibility or impossibility by evaluating said prerequisite-service condition and said data conditions, and
prompts said user to redo said service specification or said input-data specification until all of said conditions have been satisfied, and, if all of said conditions have been satisfied,
generates a message describing application data and said addable-service information, and transmits said message to said service-process providing server.

6. The service-process providing system according to claim 1, wherein
said request analysis unit, if notified of generation of said process instance from an engine,
stores data into said requested-service storage device and an application-data storage device, said data being acquired from said received message, and, if notified of state change of said process instance therefrom,
updates said requested-service storage device and said application-data storage device with said data acquired from said received message, and, if, although there exists a request for a single or more addable services to said process instance, prerequisite service for any one of said addable services has been not completed, or if there exists none of said request for said single or more addable services to said process instance,
determines a service to be executed next in accordance with said process definition, and instructs said engine to execute said service.

7. The service-process providing system according to claim 1, wherein
said request analysis unit, if notified of generation of said process instance from an engine,
stores data into said requested-service storage device and an application-data storage device, said data being acquired from said received message, and, if notified of state change of said process instance therefrom,
updates said requested-service storage device and said application-data storage device with said data acquired from said received message, and, if there exists a request for a single or more addable services to said process instance, and also if prerequisite service for any one of said addable services has been completed,
provisionally determines said addable service as a service to be executed next, and, if said addable service satisfies said data conditions,
formally determines said addable service as said service to be executed next, deletes information on said addable service from said requested-service storage device, and instructs said engine to execute said addable service.

8. The service-process providing system according to claim 1, wherein
said request analysis unit, if notified of generation of said process instance from an engine,
stores data into said requested-service storage device and an application-data storage device, said data being acquired from said received message, and, if notified of state change of said process instance therefrom,
updates said requested-service storage device and said application-data storage device with said data acquired from said received message, and, if there exists a request for a single or more addable services to said process instance, and also if prerequisite service for any one of said addable services has been completed,
provisionally determines said addable service as a service to be executed next, and, if said addable service does not satisfy said data conditions,
deletes information on said addable service from said requested-service storage device, and again, carries out said processing for determining a service to be executed next.

9. A service-process providing method in a service-process providing system comprising a single or a plurality of service-process providing servers, and a service display/input device or devices as a plurality of user clients, said server or servers and said service display/input device being connected to each other via a network, wherein said service-process providing system provides a process definition to the outside, and executes said process based on message reception from said user clients, said process definition describing execution sequence of a plurality of services,
said service-process providing server comprising a process-definition storage device for storing a process definition which includes a minimum amount of service required, an addable-service storage device for storing information on a service which a user can add to said process definition and can utilize, a service output unit for outputting, to said user clients, said information on said process definition and said addable service, a requested-service storage device for storing said information on said addable service on each process-instance basis, said addable service being requested by said user, and a request analysis unit for determining a service to be executed next during execution of each process instance,
said service-process providing method, comprising the steps of:
, in said request analysis unit, if notified of generation of said process instance from an engine,
storing data into said requested-service storage device and an application-data storage device, said data being acquired from said received message, and, if notified of state change of said process instance therefrom,
updating said requested-service storage device and said application-data storage device with said data acquired from said received message, and, if, although there exists a request for a single or more addable services to said process instance, prerequisite service for any one of said addable services has been not completed, or if there exists none of said request for said single or more addable services to said process instance, and
determining a service to be executed next in accordance with said process definition, and instructing said engine to execute said service.
